(19) United States
(12) Patent Application Publication
(10) Pub. No.: US 2025/0239256 A1
(43) Pub. Date: Jul. 24, 2025

(54) COMPUTER-IMPLEMENTED METHODS AND SYSTEMS FOR DISPLAYING TEXTUAL INFORMATION IN A NATIVE MOBILE APPLICATION

(71) Applicant: Armin Ellis, Cheyenne, WY (US)

(72) Inventor: Armin Ellis, Cheyenne, WY (US)

(21) Appl. No.: 18/418,286

(22) Filed: Jan. 21, 2024

(51) Int. Cl. G10L 15/08; G10L 15/26; G10L 21/0208

(52) U.S. Cl. CPC G10L 15/08; G10L 15/26; G10L 21/0208; G10L 2015/088

(57) ABSTRACT

According to an aspect of the present invention, there is provided a computer-implemented method for displaying relevant information and also highlighting certain communications of particular interest via a native mobile application, comprising: providing a mobile device configured for receiving communications; providing a display associated with the mobile device; installing the native mobile application on the mobile device; running the native mobile application on the mobile device; storing one or more keywords in a database associated with the native mobile application; receiving an audio input to the native mobile application; transcribing the audio input in the native mobile application and displaying a transcript on the display associated with the mobile device; and highlighting the one or more keywords of relevance in the native mobile application in the transcript displayed on the display associated with the mobile device.

### BACKGROUND

Air traffic control typically includes voice communications between air traffic controllers and pilots onboard aircraft within the designated airspace controlled. For example, an air traffic controller may communicate an instruction or a request for a pilot to ascend or descend to a particular altitude using a call sign associated with the aircraft of the pilot. A pilot onboard the aircraft may subsequently acknowledge the request in a voice communication that also includes the call sign.

One of the most common communication methods in aviation and aircraft navigation is voice communication via radio frequency transmissions. Examples include communications among pilots and Air Traffic Control. Pilots are frequently tasked with piloting an aircraft while listening and responding verbally to air traffic controller communications, which is often a difficult task due to reasons including task saturation, poor sound quality, and lack of awareness of being called. Various systems and methods have previously been proposed for managing and optimizing communications between pilots and air traffic controllers in view of this difficulty. In the particular case of aerospace and other applications where radio frequencies are shared by multiple users pertinent information may be useful to be highlighted, even if directed towards another user. Such communications may include status of other users, weather conditions, airspace congestion and other contextual information.

Speech recognition systems, and particularly systems and methods for converting speech to text have been described other than for aircraft as well. However, prior art systems and methods can be improved at least in terms of the usefulness of the output, accuracy of communications captured, ease of operation, and availability in a wide range of contexts. Additionally, the use of AI, ML, and coded processes may be used to process the communications and provide useful context and relevance to communications.

### SUMMARY OF INVENTION

While discussed for aerospace applications in this example the applications are wide ranging in applications that require communications that are structured language, formal language, or informal language.

According to an aspect of the present invention, there is provided a computer-implemented method for displaying textual information via a native mobile application, comprising: providing a mobile device configured for receiving communications; providing a display associated with the mobile device; installing the native mobile application on the mobile device; running the native mobile application on the mobile device; storing one or more keywords in a database associated with the native mobile application; receiving an audio input to the native mobile application; transcribing the audio input in the native mobile application and displaying a transcript on the display associated with the mobile device; and highlighting the one or more keywords of relevance in the native mobile application in the transcript displayed on the display associated with the mobile device.

According to another aspect of the present invention, there is provided a system for displaying textual information via a native mobile application, comprising: a mobile device configured for receiving communications; a display associated with the mobile device; a database associated with the mobile device; and an interface for receiving an audio input on the mobile device, wherein: a native mobile application is running on the mobile device; one or more keywords of relevance are stored in the database associated with the mobile device; an audio input is received by the native mobile application running on the mobile device through the interface for receiving an audio input on the mobile device; the audio input is transcribed in the native mobile application; the transcript of the audio input is displayed on the display associated with the mobile device; and the one or more keywords of relevance are displayed on the display associated with the mobile device in the native mobile application running on the mobile device.

According to yet another aspect of the present invention, there is provided a computer-readable medium having instructions stored thereon that, when executed by computer processing, cause operations comprising: installing a native mobile application on a mobile device; running the native mobile application on the mobile device; storing one or more keywords in a database associated with the native mobile application; receiving an audio input to the native mobile application; transcribing the audio input in the native mobile application and displaying a transcript on the display associated with the mobile device; and highlighting the one or more keywords of relevance in the native mobile application in the transcript displayed on the display associated with the mobile device.

### BRIEF DESCRIPTION OF THE DRAWINGS

FIG. 1 illustrates a context involving an aircraft in which embodiments of the present invention can be deployed.

FIG. 2 illustrates a mobile device running a native mobile application according to an embodiment of the present invention.

FIG. 3 illustrates highlighting one or more keywords of relevance in a native mobile application in a transcript displayed on the display associated with the mobile device.

### DETAILED DESCRIPTION

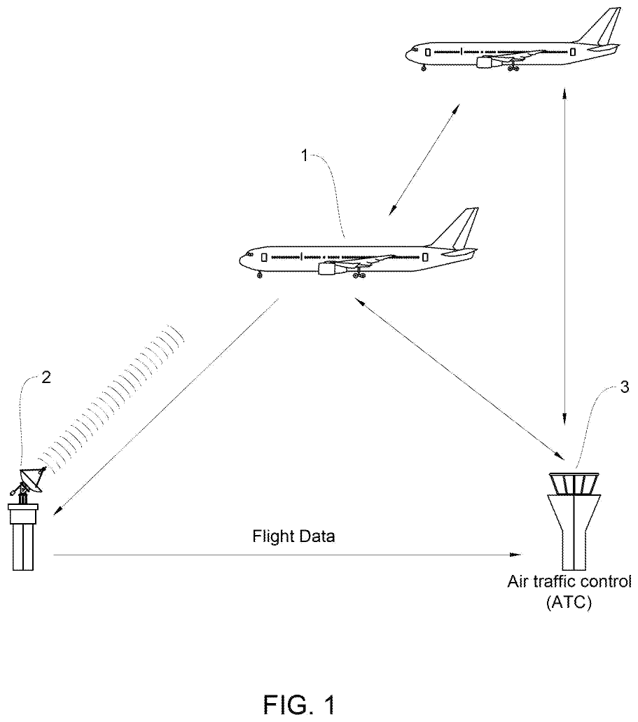

FIG. 1 illustrates a context involving an aircraft in which embodiments of the present invention can be deployed.

Aircraft 1 communicates with Remote Center Air/Ground 2 which is communication with air traffic control 3. Maximum communications coverage is possible through the use of Remote Center Air/Ground (RCAG) sites comprised of very high frequency (VHF) and ultra high frequency (UHF), and other frequency transmitters and receivers. These sites are located throughout the U.S. and in other countries. Although they may be several hundred miles away from the air traffic controller, they are remoted to the various air traffic controller by land lines or microwave links. Air Traffic Control Radar (ATC-Radar) is an umbrella term for all radar devices used to monitor air traffic. They are usually fixed radar systems located at particular geographic points, and are often remote from the location of an air traffic controller.

Embodiments of the present invention can also be used with Automatic Dependent Surveillance-Broadcast (ADS-B). ADS-B is a surveillance technique that relies on aircraft or airport vehicles broadcasting their identity, position and other information derived from on board systems. This signal (ADS-B Out) can be captured for surveillance purposes on the ground (ADS-B Out) or on board other aircraft in order to facilitate airborne traffic situational awareness, spacing, separation and self-separation (ADS-B In) ADS-B is automatic because no external stimulus is required; it is dependent because it relies on on-board systems to provide surveillance information to other parties. Finally, the data is broadcast, the originating source has no knowledge of who receives the data and there is no interrogation or two-way contract.

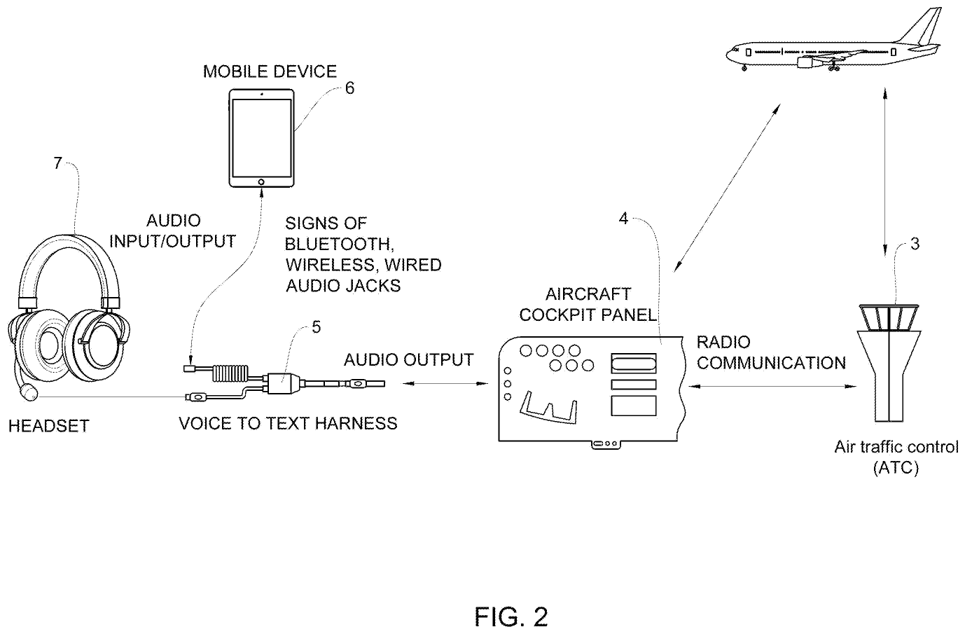

FIG. 2 illustrates a mobile device running a native mobile application according to an embodiment of the present invention.

Radio communications from air traffic control 3 can be received at aircraft cockpit panel 4 which contains a two-way radio and a transponder. There are two main components to communications with ATC, the radio and the transponder.

Pilots may have their own headsets and mobile devices which can be transferred among multiple aircraft, or aircraft can have headsets and mobile devices onboard when a pilot enters the cockpit. Pilot headset 7, mobile device 6 and cockpit panel 4 can be connected together via Y-splitter 5 or other methods. A wireless interface between Y-splitter 5, pilot headset 7 and mobile device 6 utilizing Bluetooth is also possible.

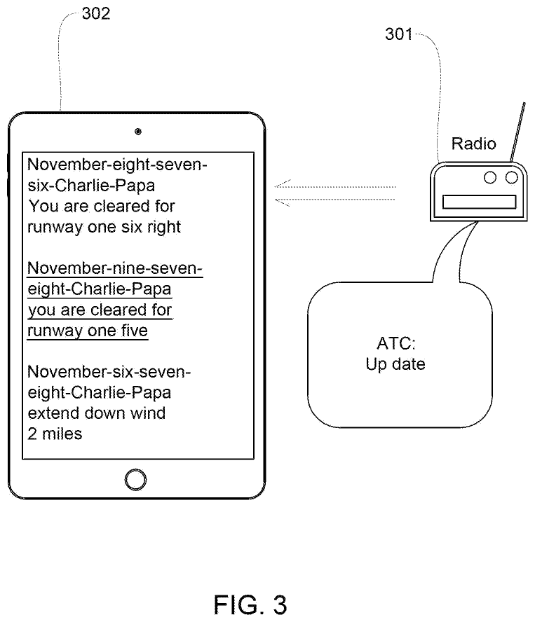

FIG. 3 illustrates highlighting one or more keywords of relevance in a native mobile application in a transcript displayed on the display associated with the mobile device.

A native mobile application is installed and running on mobile device 302. One or more keywords are stored in a database associated with the native mobile application running on mobile device 302, for example, a call sign for an aircraft on which the mobile device is situated. Unscheduled general aviation flights generally identify themselves using the call sign corresponding to the aircraft's registration number, which is typically known as a tail number in some cases, and is printed on the tail of an aircraft. A call sign is used by air traffic control to identify and communicate with a specific aircraft, and thus is important to highlight.

An audio input is received via radio 301 which is in communication with air traffic control. Audio input from radio 301 is obtained on the mobile device as shown, for example, in the embodiment of FIG. 2. Audio input from radio 301 is transcribed as text in the native mobile application and a transcript is displayed on the display associated with the mobile device 302.

On the transcript displayed on mobile device 302, one or more keywords of relevance are highlighted. An entire sentence or phrase containing the call sign of the aircraft on which the mobile device is situated can be highlighted, for example. In the example of FIG. 3, the call sign of the aircraft is November-niner-seven-eight-Charlie-Papa because the example aircraft registration number on which the mobile device is situated is N978CP. In FIG. 3, the communication from air traffic control “November-niner-seven-eight-Charlie-Papa you are cleared for runway one five right” is highlighted because it pertains to the aircraft of interest, typically on which the mobile device is situated. November 978CP may be referred to in other ways such as 978CP or 78CP or 8CP or CP, and will be recognized as aircraft of intent.

Usually multiple aircraft are tuned in to the same frequency such as air traffic control radio, with pilots of multiple aircraft being told to switch to that frequency at particular points in flight. The present invention provides the pilot with a tool to focus their attention towards only those communications on the frequency assigned to multiple aircraft which pertain to the pilot's aircraft. In FIG. 3, other communications from air traffic control are displayed on mobile device 302. “November-eight-seven-six-Charlie-Papa you are cleared for runway one six right” corresponds to an instruction to an aircraft having tail number N876CP and “November-six-seven-eight-Charlie-Papa you are cleared for runway one seven right” corresponds to an instruction to an aircraft having tail number N678CP. Neither of those aircraft is N978CP, the exemplary aircraft on which the embodiment of the native mobile application according to the present invention is running. Accordingly, those communications from air traffic control are not highlighted, and the burden on the pilot is alleviated to a substantial extent due to the present invention highlighting only the communications from air traffic control on the transcript which pertain to the pilot's aircraft. Other communications for other aircraft may or may not be displayed.

Having thus described a few particular embodiments of the invention, various alterations, modifications, and improvements will readily occur to those skilled in the art. Such alterations, modifications, and improvements are intended to be part of this description though not expressly stated herein, and are intended to be within the spirit and scope of the invention. Accordingly, the foregoing description is by way of example only of several of many potential embodiments, and not limiting.

What is claimed is:

1. A computer-implemented method for displaying textual information via a native mobile application, comprising:
providing a mobile device configured for receiving communications;
providing a display associated with the mobile device;
installing the native mobile application on the mobile device;
running the native mobile application on the mobile device;
storing one or more keywords in a database associated with the native mobile application;
receiving an audio input to the native mobile application;
transcribing the audio input in the native mobile application and displaying a transcript on the display associated with the mobile device; and
highlighting the one or more keywords of relevance in the native mobile application in the transcript displayed on the display associated with the mobile device.

2. The method of claim 1, further comprising providing a signal filter in the native mobile application adapted to optimize speech recognition functions in environments with background noise.

3. The method of claim 1, wherein a keyword is a vessel call sign.

4. The method of claim 3, wherein the vessel is an aircraft.

5. The method of claim 1, wherein the audio input originates from a radio frequency communication.

6. The method of claim 5, wherein the radio frequency communication is sent from air traffic control and other aircraft.

7. The method of claim 5, wherein the audio input is received via a wired connection branching off from a line running to a headset.

8. The method of claim 5, wherein the audio input is received via a Bluetooth connection from a device on a line running to a headset or an audio speaker internal to a vessel.

9. The method of claim 3, wherein the vessel call sign is received automatically by the mobile device via an application programming interface.

10. The method of claim 1, wherein the native mobile application blocks other operations on the mobile device while the device sense it is in motion.

11. A system for displaying textual information via a native mobile application, comprising:
a mobile device configured for receiving communications;
a display associated with the mobile device;
a database associated with the mobile device; and
an interface for receiving an audio input on the mobile device, wherein:
a native mobile application is running on the mobile device;
one or more keywords of relevance are stored in the database associated with the mobile device;
an audio input is received by the native mobile application running on the mobile device through the interface for receiving an audio input on the mobile device;
the audio input is transcribed in the native mobile application;
the transcript of the audio input is displayed on the display associated with the mobile device; and
the one or more keywords of relevance are displayed on the display associated with the mobile device in the native mobile application running on the mobile device.

12. The system of claim 11, further comprising a headset for receiving an audio input.

13. The system of claim 11, further comprising a wired connection branching off from a line running to the headset.

14. The system of claim 11, further comprising a Bluetooth connection from a device on a line running to the headset.

15. The system of claim 11, further comprising a transponder for receiving radio frequency communications.

16. The system of claim 15, wherein the transponder is a transponder on an aircraft.

17. The system of claim 11, further comprising one or more of an altimeter and an airspeed indicator.

18. A computer-readable medium having instructions stored thereon that, when executed by computer processing, cause operations comprising:
installing a native mobile application on a mobile device;
running the native mobile application on the mobile device;
storing one or more keywords in a database associated with the native mobile application;
receiving an audio input to the native mobile application;
transcribing the audio input in the native mobile application and displaying a transcript on the display associated with the mobile device; and
highlighting the one or more keywords of relevance in the native mobile application in the transcript displayed on the display associated with the mobile device.

19. The computer-readable medium according to claim 18, further comprising a database storing one or more vessel call signs.

20. The computer-readable medium according to claim 18, wherein the computer-readable medium contains instructions to block other operations on the mobile device while a vehicle is in motion.
